(19) United States
(12) Patent Application Publication
(10) Pub. No.: US 2014/0265698 A1
(43) Pub. Date: Sep. 18, 2014

(54) Electric Generator with a Transverse Magnetic Field

(71) Applicant: NATIONAL YUNLIN UNIVERSITY OF SCIENCE AND TECHNOLOGY, Douliou City (TW)

(72) Inventor: Wan-Tsun Tseng, Douliou City (TW)

(73) Assignee: National Yunlin University of Science and Technology, Douliou City (TW)

(21) Appl. No.: 13/838,771

(22) Filed: Mar. 15, 2013

(51) Int. Cl. H02K 1/27

(52) U.S. Cl. CPC H02K 1/2786
USPC 310/156.02

(57) ABSTRACT

An electric generator with a transverse magnetic field has an enclosing unit, a rotor unit and a stator unit. The rotor unit is mounted in the enclosing unit and has multiple pairs of permanent magnets. The stator unit has multiple magnetizers. Each magnetizer is wound around by a winding, and has two magnetizing blocks oppositely mounted on two ends of the magnetizer to correspond to a corresponding pair of permanent magnets. When the rotor unit is rotated, a magnetic field passes through the magnetizing blocks and the winding on each magnetizer to generate power. The electric generator is a single-phase or multi-phase electric generator depending on whether a pair number of the permanent magnets is or is not equal to a number of the magnetizers. As having multiple magnetizers and multiple windings, the stator unit can increase a total magnetic flux passing therethrough for the electric generator to generate more power.

### BACKGROUND OF THE INVENTION

1. Field of the Invention

The present invention relates to an electric generator with a transverse magnetic field and more particularly to an electric generator with a transverse magnetic field having multiple magnetizers and multiple windings mounted on a stator unit to increase entire magnetic flux of a stator unit.

2. Description of the Related Art

Every conventional electric generator has a stator unit and a rotor unit. The rotor unit has multiple pairs of permanent magnets and is rotatable relative to the stator unit. For power generation under a transverse magnetic field, a direction of motion of the rotor unit is perpendicular to the magnetic field. Hence, power generation under a transverse magnetic field can shorten the polar distance of each pair of permanent magnets and the size of an electric generator with a transverse magnetic field can be reduced. However, the stator unit of the conventional electric generator is formed by a solid iron core, and the magnetic flux of the stator unit is unable to increase after the magnetic flux inside the iron core is saturated. To generate more power, the total magnetic flux inside the iron core should be increased indicative of the need of a larger iron core for generating more magnetic flux. As a result, the size and weight of the permanent magnets in the stator unit and the windings in the stator unit should be also increased. When the electric generator is mounted on, for example, a bicycle, its size and weight creates a load burden to the cyclist.

### SUMMARY OF THE INVENTION

An objective of the present invention is to provide an electric generator with a transverse magnetic field capable of increasing a total magnetic flux and generating more power by using multiple magnetizers and multiple windings.

To achieve the foregoing objective, the electric generator with a transverse magnetic field has an enclosing unit, a rotor unit and a stator unit.

The enclosing unit has a tubular case. The case has an inner wall.

The rotor unit is mounted inside the enclosing unit, is securely mounted on the inner wall of the case, and has multiple magnetic bars and multiple pairs of permanent magnets. Each pair of permanent magnets is respectively mounted on two ends of one of the magnetic bars.

The stator unit has a stator core, multiple magnetizers and multiple windings.

The stator core has two opposite ends and multiple partition blocks. The partition blocks are radially and respectively formed on the two opposite ends of the stator core and mutually spaced by a slot.

Each magnetizer has a magnetizing rod and two magnetizing blocks. The magnetizing blocks are respectively formed on two ends of the magnetizing rod. The magnetizing blocks on two ends of each magnetizing rod correspond to a corresponding pair of permanent magnets and are inserted into two opposite slots on the two ends of the stator core.

Each winding is wound around the magnetizing rod of a corresponding magnetizer.

Alternatively, an electric generator with a transverse magnetic field has an enclosing unit, a stator unit and a rotor unit.

The enclosing unit has a tubular case. The case has an inner wall.

The stator unit has a stator core, multiple magnetizers and multiple windings. The stator core has two opposite ends. Each magnetizer has a magnetizing rod and two magnetizing blocks.

The magnetizing blocks are respectively formed on two ends of the magnetizing rod. The magnetizing blocks on two ends of each magnetizing rod correspond to a corresponding pair of permanent magnets and are inserted into two opposite slots on the two ends of the stator core.

Each winding is wound around the magnetizing rod of a corresponding magnetizer.

The rotor unit is mounted inside the stator unit, is securely mounted on the inner wall of the case, and has a rotor core, multiple magnetic bars and multiple pairs of permanent magnets.

The rotor core has multiple partition blocks radially and respectively formed around peripheries of two opposite ends of the rotor core and mutually spaced by a slot.

Each magnetic bar is inserted in two opposite slots on two ends of the rotor core.

Each pair of permanent magnets is respectively mounted on two ends of one of the magnetic bars.

Preferably, the electric generator is a single-phase electric generator when a pair number of the permanent magnets is equal to a number of the magnetizers.

Preferably, the electric generator is a multi-phase electric generator when a pair number of the permanent magnets is greater or less than a number of the magnetizers.

Given the foregoing single-phase or multi-phase electric generator with a transverse magnetic field, when the rotor unit is rotated, each pair of permanent magnets on two ends of the rotor unit generates a magnetic field looping from one of the pair of permanent magnets, a corresponding magnetizer and the other of the pair of permanent magnets, a corresponding magnetic bar back to the originating permanent magnet for the winding of the corresponding magnetizer to generate power. As having multiple magnetizers, the stator unit can increase a total magnetic flux therethrough. From the foregoing, by increasing the loops of the magnetic field through the magnetizers, the total magnetic flux of the electric generator can be also increased without increasing the size of the electric generator. Accordingly, the issue of increasing size and weight of the electric generator for sake of higher power generation can be resolved.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of an electric generator with a transverse magnetic field in accordance with the present invention;

FIG. 2 is a cross-sectional side view of the electric generator in FIG. 1;

FIG. 3 is a partially exploded view of a rotor unit of the electric generator in FIG. 1;

FIG. 4 is a front view in partial section of the electric generator in FIG. 1;

FIG. 5 is a front view in partial section of a second embodiment of an electric generator with a transverse magnetic field in accordance with the present invention; and

FIG. 6 is a cross-sectional side view of a third embodiment of an electric generator in accordance with the present invention.

### DETAILED DESCRIPTION OF THE INVENTION

With reference to FIG. 1, a first embodiment of an electric generator with a transverse magnetic field in accordance with the present invention has an enclosing unit 10, a rotor unit 20 and a stator unit 30.

With reference to FIG. 2, the enclosing unit 10 has a tubular case 11, two bearings 12 and two covers 13. The case 11 has an inner wall and two open ends. Each bearing 12 has a through hole centrally formed therethrough. Each cover 13 is mounted on the inner wall of the case 11 at one of the open ends and has a coupling hole centrally formed therethrough for one of the bearings 12 to be mounted in the coupling hole.

The rotor unit 20 is mounted inside the enclosing unit 10 and is securely mounted on the inner wall of the case 11, and has multiple magnetic bars 21 and multiple pairs of permanent magnets 22, 22′. Each pair of permanent magnets 22, 22′ is securely mounted on two ends of one of the magnetic bars 21 in a transverse direction. With reference to FIG. 2, the permanent magnet 22 of each pair on one end of a corresponding magnetic bar 21 is an N-pole magnet, and the other permanent magnet 22′ of each pair on the other end of the corresponding magnetic bar 21 is a S-pole magnet.

The stator unit 30 is mounted inside the rotor unit 20, and has a stator core 31, multiple magnetizers 32, a shaft 33 and multiple windings 34. With reference to FIG. 3, the stator core 31 is cylindrical and has multiple partition blocks 312. The partition blocks 312 are radially and respectively formed around peripheries of two opposite ends of the stator core 31 and are mutually spaced by a slot 311. Each magnetizer 32 has a magnetizing rod 322 and two magnetizing blocks 321. The magnetizing blocks 321 are respectively formed on two ends of the magnetizing rod 322. The magnetizing blocks 321 on two ends of each magnetizing rod 322 correspond to a corresponding pair of permanent magnets 22, 22′, and are inserted into two opposite slots 311 on the two ends of the stator core 31. The shaft 33 is mounted through the two through holes of the two bearings 12. Each winding 34 is wound around the magnetizing rod 322 of a corresponding magnetizer 32.

With further reference to FIG. 2, when the rotor unit 20 is rotated, each pair of permanent magnets 22, 22′ on the two ends of the stator unit 20 generates a magnetic field whose lines of the magnetic field originate from the N-pole permanent magnet 22 of a corresponding pair of permanent magnets 22, 22′, pass through a corresponding magnetizer 32, the S-pole permanent magnet 22′ of the corresponding pair of permanent magnets 22, 22′, a corresponding magnetic bar 21, and loop back to the N-pole permanent magnet 22 of the corresponding pair of permanent magnets 22, 22′, so that the winding 34 on the magnetizing rod 322 of a corresponding magnetizer 32 can generate power. As having the multiple windings 34 respectively mounted on the magnetizers 32, the stator unit 30 can increase a total magnetic flux through all the magnetic fields.

With reference to FIG. 4, in the present embodiment, there are six magnetic bars 21 and six pairs of permanent magnets 22, 22′. The permanent magnet 22 on one side of each pair of permanent magnets 22, 22′ is an N-pole magnet, and the permanent magnet 22′ of another adjacent pair of permanent magnets 22, 22′, which is adjacent to the N-pole magnet, is a S-pole magnet. The polarities of the permanent magnets 22/22′ mounted on each end of the rotor unit 20 are alternately arranged. The stator unit 30 has six slots 311 formed in the stator core 31 and has six magnetizers 32. The six magnetizers 32 correspond to the six pairs of permanent magnets 22, 22′ on the rotor unit 20 so as to generate a single-phase power when the rotor unit 20 is rotated.

With reference to FIG. 5, a second embodiment of an electric generator with a transverse magnetic field in accordance with the present invention is a multi-phase electric generator with a transverse magnetic field differs from the foregoing embodiment in that a pair number of the permanent magnets 22, 22′ is not equal to a number of magnetizers 32. Hence, a multi-phase power can be acquired. In the present embodiment, the stator unit 30 has nine slots 311 formed in the stator core 31 and nine magnetizers 32. When the rotor unit 20 is rotated, the nine magnetizers 32 are aligned with the six pairs of permanent magnets 22, 22′ in turn and multi-phase power can be generated. In other words, when the pair number of the permanent magnets 22, 22 is equal to the number of the magnetizers 32, a single-phase electric generator with a transverse magnetic field is provided, and when the pair number of the permanent magnets 22, 22 is greater or less than the number of the magnetizers 32, a multi-phase electric generator with a transverse magnetic field is provided.

With reference to FIG. 6, a third embodiment of a single-phase or multi-phase electric generator with a transverse magnetic field in accordance with the present invention has an enclosing unit 10, a stator unit 30, and a rotor unit 20.

The enclosing unit 10 has a tubular case 11, two bearings 12 and two covers 13. The case 11 has an inner wall and two open ends. Each bearing 12 has a through hole centrally formed therethrough. A shaft 33 is mounted through the through holes of the bearings 12. Each cover 13 is mounted on the inner wall of the case 11 at one of the open ends and has a coupling hole centrally formed therethrough for one of the bearings 12 to be mounted in the coupling hole.

The stator unit 30 is mounted inside the enclosing unit 10, is securely mounted on the inner wall of the case 11, and has multiple magnetizers 32 and multiple windings 34. Each magnetizer 32 has a magnetizing rod 322, and two magnetizing blocks 321. The magnetizing blocks 321 are respectively formed on two ends of the magnetizing rod 322, and are mounted in the inner wall of the case 11. Each winding 34 is wound around the magnetizing rod 322 of a corresponding magnetizer 32.

The rotor unit 20 is rotatably mounted inside the stator unit 30, is mounted around the shaft 33 to be rotated relative to the stator unit 30, and has a rotor core 23, multiple magnetic bars 21 and multiple pairs of permanent magnets 22, 22′. The rotor core 23 is structurally similar to the stator core 31 in the foregoing embodiment and has multiple partition blocks radially and respectively formed around peripheries of two opposite ends of the rotor core 23, and the partition blocks are mutually spaced by a slot. Each magnetic bar 21 is inserted in two opposite slots on two ends of the rotor core 23. Each pair of permanent magnets 22, 22′ is securely mounted on two ends of one of the magnetic bars 21 in a transverse direction, and corresponds to the magnetizing blocks 321 on two ends of a corresponding magnetizer 32. When the pair number of the permanent magnets 22, 22 is equal to the number of the magnetizers 32, a single-phase electric generator with a transverse magnetic field is provided, and when the pair number of the permanent magnets 22, 22 is greater or less than the number of the magnetizers 32, a multi-phase electric generator with a transverse magnetic field is provided.

From the foregoing, when the rotor unit 20 is rotated, the multiple pairs of permanent magnets will generate a magnetic field, and the magnetic flux through the windings 34 can be increased with the magnetic field passing through the magnetizers 32 and the windings 34 to generate more electric power.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An electric generator with a transverse magnetic field, comprising:
an enclosing unit having a tubular case, wherein the case has an inner wall;
a rotor unit mounted inside the enclosing unit, securely mounted on the inner wall of the case, and having:
multiple magnetic bars; and
multiple pairs of permanent magnets, each pair of permanent magnets respectively mounted on two ends of one of the magnetic bars; and
a stator unit having:
a stator core having:
two opposite ends; and
multiple partition blocks radially and respectively formed on the two opposite ends of the stator core and mutually spaced by a slot;
multiple magnetizers, each magnetizer having:
a magnetizing rod; and
two magnetizing blocks respectively formed on two ends of the magnetizing rod, wherein the magnetizing blocks on two ends of each magnetizing rod correspond to a corresponding pair of permanent magnets and are inserted into two opposite slots on the two ends of the stator core; and
multiple windings, each winding wound around the magnetizing rod of a corresponding magnetizer.

2. The electric generator as claimed in claim 1, being a single-phase electric generator with a transverse magnetic field when a pair number of the permanent magnets is equal to a number of the magnetizers.

3. The electric generator as claimed in claim 1, being a multi-phase electric generator with a transverse magnetic field when a pair number of the permanent magnets is greater or less than a number of the magnetizers.

4. An electric generator with a transverse magnetic field, comprising:
an enclosing unit having a tubular case, wherein the case has an inner wall;
a stator unit having:
a stator core having two opposite ends;
multiple magnetizers, each magnetizer having:
a magnetizing rod; and
two magnetizing blocks respectively formed on two ends of the magnetizing rod, wherein the magnetizing blocks on two ends of each magnetizing rod correspond to a corresponding pair of permanent magnets and are inserted into two opposite slots on the two ends of the stator core; and
multiple windings, each winding wound around the magnetizing rod of a corresponding magnetizer; and
a rotor unit mounted inside the stator unit, securely mounted on the inner wall of the case, and having:
a rotor core having multiple partition blocks radially and respectively formed around peripheries of two opposite ends of the rotor core and mutually spaced by a slot;
multiple magnetic bars, each magnetic bar inserted in two opposite slots on the two ends of the rotor core; and
multiple pairs of permanent magnets, each pair of permanent magnets respectively mounted on two ends of one of the magnetic bars.

5. The electric generator as claimed in claim 4, being a single-phase electric generator with a transverse magnetic field when a pair number of the permanent magnets is equal to a number of the magnetizers.

6. The electric generator as claimed in claim 4, being a multi-phase electric generator with a transverse magnetic field when a pair number of the permanent magnets is greater or less than a number of the magnetizers.
